(19) United States
(12) Patent Application Publication
(10) Pub. No.: US 2007/0051242 A1
(43) Pub. Date: Mar. 8, 2007

(54) Configurations and methods for assisted condensation

(76) Inventor: Viktor I. Petrik, St. Petersburg (RU)

Correspondence Address: ROBERT D. FISH;RUTAN & TUCKER LLP, 611 ANTON BLVD 14TH FLOOR, COSTA MESA, CA, 92626-1931, US

(21) Appl. No.: 11/223,488

(22) Filed: Sep. 8, 2005

(51) Int. Cl. B01D 53/02

(52) U.S. Cl. 96/108

(57) ABSTRACT

A condensation enhancer has a carrier to which carbonaceous nanostructured material is coupled such that a compound in gas phase contacting the enhancer condenses at a temperature that is higher than a condensation temperature of the compound on the condensation enhancer without the nanostructured material.

### FIELD OF THE INVENTION

The field of the invention is devices and methods for condensation of a gaseous compound, and especially of at least partially substituted hydrocarbons from air.

### BACKGROUND OF THE INVENTION

Hydrocarbons released into the atmosphere raise serious environmental concerns and there is a continuing need for new ways to reduce the presence of hydrocarbon in the atmosphere.

Generally known methods of reducing the presence of hydrocarbon in the atmosphere includes the process of sorption. Sorption is a general term for physical and chemical absorption and adsorption, using a more or less specific sorbent to remove ions or molecules. Adsorption is a type of adhesion which takes place at the surface of a solid or a liquid in contact with liquid or gases. Adsorption results in the accumulation of molecules of gases, or ions or molecules of liquids, at the surfaces of contacting solids or liquids. Absorption, on the other hand, is a process in which particles of gas or liquid enter another solid (or liquid, in the case of gas) material. This is a different process from adsorption, since the particles are taken by the volume, not by surface.

Activated charcoal is frequently employed for adsorption of solvents from paint operations. Among other advantages, using charcoal is relatively inexpensive, biologically inert and non-toxic, and can be easily disposed of. Despite numerous desirable properties, however, activated charcoal has several disadvantages.

For example, the sorption capacity of activated charcoal is relatively limited and typically determined by the pore size and volume. Moreover, not all compounds can be retained by activated charcoal. Still further, most activated charcoal preparations are at least somewhat hydrophilic and therefore suffer from loss of capacity where the activated charcoal is used in a humid or aqueous environment.

Further, adsorption by sorbent in general requires the extra step of regeneration to retrieve hydrocarbon collected by the sorbent. This step is typically done using vacuum, steam, microwave irradiation, or other heating procedures. Besides the inconvenience of having this extra step, regeneration requires additional equipments which takes up space, requires relatively large amounts of energy, and makes adsorption a costly and an undesirable way to reduce the presence of hydrocarbon in the atmosphere.

Another known method of reducing the presence of hydrocarbon in the atmosphere is through solvent absorption. Solvent absorption involves spraying the medium carrying hydrocarbon with an appropriate solvent mist, allowing the solvent mist to absorb the hydrocarbon vapor, and then extract the absorbed hydrocarbon from the solvent using a stripper.

This stripping procedure, similar to the regeneration procedure discussed above, increases cost and requires relatively large amounts of energy. The equipment needed for chemical stripping also takes up precious space, thus making solvent absorption undesirable to remove hydrocarbon from gaseous medium.

Yet another common method of reducing the presence of hydrocarbon in the atmosphere involves using refrigeration to condense hydrocarbons from the gas phase. For example, condensation is widely used in petroleum storage tanks found in petroleum refineries and retail gas stations. As these storage tanks are refueled, the newly introduced fuel displaces gases in the storage tank having hydrocarbon vapors. Without further processing, the displaced gases would escape into the atmosphere. Displaced gases is processed by passing it through condensation units allowing hydrocarbon vapors to condense.

While condensation provides a relatively effective way to reduce the presence of hydrocarbon in the atmosphere, various disadvantages nevertheless remain. Among other things, thorough removal of hydrocarbons using condensation requires relatively large amounts of energy for condensation to take place.

Therefore, while various devices and methods for removing gaseous hydrocarbon are known in the art, all or most of them suffer from one or more disadvantages, especially the requirement of relatively large amounts of energy and additional space for refrigeration units. Thus, there remains a considerable need for devices and methods for reducing the presence of gaseous hydrocarbon in the atmosphere.

### SUMMARY OF THE INVENTION

The present inventive subject matter comprises devices and methods in which a condensation enhancer has carbonaceous nanostructured material, where in nanostructured material allows a compound in gas phase contacting the enhancer to condense at a temperature that is higher than a condensation temperature of the compound on the condensation enhancer without the nanostructured material.

Among the many different possibilities contemplated, the condensation enhancer may have an opening where gaseous compound passes through, and may further include a refrigerator coupled to the condensation enhancer. It is further contemplated that the carbonaceous material may be non-porous, and preferably having a smallest dimension of less than 100 nm, more preferably 50 nm, and most preferably 10 nm.

Further, it is contemplated that the nanostructured material be made from the group consisting of a graphene, a carbon nanotube, and a fullerene. In the alternative, the nanostructured material is not carbonaceous, but may be other materials such as silica. It is still further contemplated that the target compound for condensation is at least partially substituted and at least partially unsaturated hydrocarbon having a boiling point of less than 100° C.

Contemplated condensation enhancers can have a thermal unit coupled to the enhancer and controlled by a controller to provide a temperature at the enhancer effective to condense a compound in a gas phase when the compound contacts the enhancer. It is further contemplated that the controller is configured to set the temperature to a temperature that is higher than a temperature that is required to condense the compound on the condensation enhancer without the nanostructured material.

In preferred embodiments the temperature at the enhancer effective to condense the compound in the gas phase is between 15° C. and −45° C.

Among the many possible compounds contemplated for condensation, it is preferred that the compound is gasoline vapors.

In other preferred embodiments, the condensation enhancer is coupled to a distillation column, such as those used in oil refineries.

In still further preferred embodiments, the condensation enhancer is coupled to a storage tank, including those used in gas stations, tanker trucks, tanker vessels, and planes.

Another aspect of the invention is directed to methods of removing a compound in gas phase from a medium, comprising the steps of: (a) providing a condensation enhancer comprising a carrier coupled to a carbonaceous nanostructured material; and (b) contacting the enhancer with the medium at a temperature at which the compound condenses.

The compound preferably is at least partially substituted hydrocarbon and wherein the preferred medium is air. It is further contemplated that the step of contacting includes fluidly coupling the enhancer to a conduit through which the medium is passed.

In achieving the temperature of condensation, it is preferred that a refrigeration unit is used. Further, the enhancer may be configured as a cold exchanger, and wherein the enhancer is coated with the carbonaceous nanostructured material. It is still further contemplated that the carbonaceous nanostructured material comprises a material selected from the group consisting of a graphene, a carbon nanotube, and a fullerene.

Various objects, features, aspects and advantages of the present invention will become more apparent from the following detailed description of preferred embodiments of the invention, along with the accompanying drawings in which like numerals represents like components.

### BRIEF DESCRIPTION OF THE DRAWING

FIG. 1 is an schematic depicting an embodiment of the invention coupled to a storage tank.

FIG. 2 is a schematic depicting another embodiment of the invention coupled to a distillation column.

FIG. 3A is a graphical representation of a contemplated carrier coupled with carbonaceous nanostructured material.

FIG. 3B is an graphical representation of another embodiment of the carrier coupled with carbonaceous nanostructured material.

### DETAILED DESCRIPTION

The inventors have discovered that nanostructured materials, and especially non-porous carbonaceous materials with a smallest dimension of equal or less than 100 nm, can be used as surface coating in gas treatment processes. In particular, where condensation is used to condense hydrocarbon gases, the temperature required to condense such gases is lowered if the condensation device has nanostructured materials coated on its gas contacting surfaces. Consequently, this coating lowers the energy requirement for condensing a target compound. It is particularly contemplated that the carbonaceous material includes a structure selected from the group comprising of a graphene, a carbon nanotube(e.g., single- or multi-walled carbon nanotubes), fullerene, and spheroid (e.g., nanoonions, nanodiamonds).

As used herein, the term “non-porous” in conjunction with a material refers to a porosity (i.e., void space within the material itself) of the material of less than 5 vol %, and even more typically of less than 2 vol %. For example, a material having a total volume of 10 cubic micrometer is considered non-porous if that material has a total pore volume of less than 0.5 cubic micrometer. It should be noted that the annular space defined by a carbocyclic ring is not considered a pore under the definition provided herein. Also, where a material has a contorted shape (e.g., a graphene in a wrinkled, sheet-like configuration) within a given volume, the void space between the material in that volume is not considered a pore under the definition provided herein.

As used herein, “nanostructured material” will typically have a smallest dimension of less than 100 nm, more typically less than 50 nm, and most typically less than 10 nm.

As used herein, the term “graphene” refers to a molecule in which a plurality of carbon atoms (e.g., in the form of five-membered rings, six-membered rings, and/or seven-membered rings) are covalently bound to each other to form a (typically sheet-like) polycyclic aromatic molecule. Consequently, and at least from one perspective, a graphene may be viewed as a single layer of carbon atoms that are covalently bound to each other (most typically sp² bonded). It should be noted that such sheets may have various configurations, and that the particular configuration will depend (among other things) on the amount and position of five-membered and/or seven-membered rings in the sheet. For example, an otherwise planar graphene sheet consisting of six-membered rings will warp into a cone shape if a five-membered ring is present the plane, or will warp into a saddle shape if a seven-membered ring is present in the sheet. Furthermore, and especially where the sheet-like graphene is relatively large, it should be recognized that the graphene may have the electron-microscopic appearance of a wrinkled sheet. It should be further noted that under the scope of this definition, the term “graphene” also includes molecules in which several (e.g., two, three, four, five to ten, one to twenty, one to fifty, or one to hundred) single layers of carbon atoms (supra) are stacked on top of each other to a maximum thickness of less than 100 nanometers. Consequently, the term “graphene” as used herein refers to a single layer of aromatic polycyclic carbon as well as to a plurality of such layers having a thickness of less than 100 nanometers. Typically, the dangling bonds on the edge of the graphene are saturated with a hydrogen atom. The term “about” where used in conjunction with a numeral refers to a numeric range of ±10% of the numeral, inclusive. For example, the term “about 100” refers to a numerical value of between 90 and 110, inclusive.

As further used herein, the term “carbon nanotube” refers to a cylindrical single- or multi-walled structure in which the wall(s) is (are) predominantly composed of carbon, wherein the diameter may be uniform or decreasing over the length of the nanotube. In some instances, the carbon nanotube can be curved, and is therefore also termed “carbon nanohorn”.

In one preferred aspect of the inventive subject matter, the carbonaceous material is a bulk graphene preparation that is commercially available (e.g., from SupraCarbonic, 1030 West 17th Street, Costa Mesa, Calif. 92627). Alternatively, contemplated graphene composition may also be prepared from graphite, coal, tar, etc. as described in our copending application with the Ser. No. 11/007614, which is incorporated by reference herein. Depending on the starting material, reaction conditions, and other parameters, the non-porous carbonaceous material will typically have a smallest dimension of less than 100 nm, more typically less than 50 nm, and most typically less than 10 nm. It should be noted that (similar to purified carbon nanotubes) a significant fraction of the graphene material will aggregate to form a light-weight material in which the graphene layers typically have a contorted configuration. Where more disaggregated material or even isolated graphene layers are desired, it should be recognized that the aggregated material may be dispersed using chemical and/or physical treatments (e.g., one or more solvents, heat, microwave radiation, and/or ultrasound irradiation).

For example, suitable solvents include various amides, alcohols, benzene, acetone, those described in US2003/0001141 (incorporated by reference herein), and mixtures thereof. With respect to heat treatment, it should be noted that the temperature is at least to some degree dependent on the environment in which the graphene preparation is present. For example, where the graphene is in a solvent, the upper temperature is typically determined by the boiling point under normal pressure. However, higher temperatures may also be used at elevated pressure. Similarly, lower temperatures are also deemed suitable. Where the environment is an oxygen-containing gas phase and dangling bonds are present, it is typically preferred that the temperature is below 400° C. However, higher temperature (e.g., between 400° C. and 1000° C., or between 1000° C. and 3000° C.) are also contemplated. Microwave and/or ultrasound irradiation are typically performed using energies of less than 1000 W over a period of time that is non-destructive to the graphene material, and it should be recognized that the proper conditions can be readily determined (e.g., using SEM or TEM) without undue experimentation.

Still further contemplated alternative suitable materials include carbon fractals, branched nanotubes, and other irregularly shaped carbonaceous material so long as such material is non-porous and has a smallest dimension of less than 100 nm. Exemplary materials are disclosed in our copending application with the Ser. No. 11/007614 (supra). Additionally, it should be appreciated that the materials contemplated herein may be derivatized in numerous manners, and especially contemplated derivatizations include metal deposition (and especially with noble metals), derivatization with elements or compounds that produce semi-conductor characteristics (e.g., boron doped), and chemical modification of one or more carbon atoms within the graphene plane and/or edge. Most preferably, metal deposition is performed in which the metal provided from a gas phase (e.g., CVD, PVD, etc.), but other forms are also deemed suitable, including electroless deposition, electrolytic deposition, etc. Chemical modification of the graphene will generally follow known procedures for chemical derivatization of carbon nanotubes, which is well known in the art (e.g., exemplary covalent derivatization methods are described in J. Mater. Res., Vol. 13, No. 9, (1998) p 2423-2431; in Chem. Eur. J. 2003, 9, 4000-4008, or in U.S. Pat. No. 6,187,823, 6,426,134, WO 98/39250, and WO 00/17101, all of which are incorporated by reference herein). Non-covalent derivatization may be achieved by adding derivatized polycyclic aromatic compounds to the graphene compositions to achieve Van-der-Waals anchoring to the graphene.

Depending on the particular use, it should be recognized that the non-porous carbon composition may be at least partially disaggregated (e.g., to provide isolated graphene layers via solvent disaggregation and dilution), at least partially aggregated (e.g., to increase particle size), compacted, or even compressed to form a solid material that can be further reshaped if desired. Where the carbonaceous material is derivatized, it should be recognized that the derivatization groups may be employed to crosslink the carbonaceous material, or to covalently or non-covalently bind the carbonaceous material to another material. Furthermore, and especially where a relatively low density of the carbonaceous material is desirable, hydrophobic and/or hydrophilic fillers may be admixed to the carbonaceous material. For example, suitable fillers include glass fibers, polymeric fibers, vermiculite, fulmed silica, mineral products (e.g., clay, carbonates, . . . ), etc. While not limiting to the inventive concept presented herein, it is typically preferred that the carbonaceous non-porous material is used in bulk quantities, which are typically quantities of at least 0.5 gram, more typically at least 5 gram, even more typically at least 50 gram, and most typically at least 500 gram.

As for coating of the nanostructured material, the coating may be done in numerous manners, including spray coating from or dip coating in a solution that includes the carbonaceous material. Alternatively, electrostatic coating, or even use of an intermediary material (e.g., high- or low tack adhesive) is contemplated. Furthermore, and especially where the carbonaceous material is derivatized, it should be recognized that the material may also be covalently coupled to the second material.

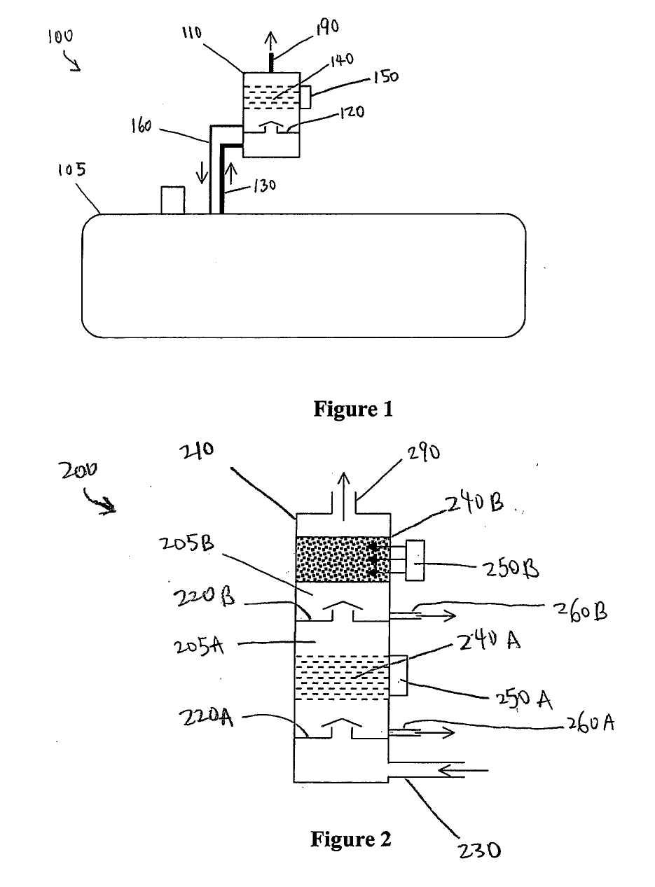

FIG. 1 generally depicts a petroleum storage unit 100, having a condensation device 110 coupled to a storage tank 105.

Operation of the storage unit is straight forward. In preferred embodiments, gases having hydrocarbon vapors travel from tank 105 to condensation device through inlet 130. Condensation device 110, having condensation enhancer 140 coupled to a refrigerator 150, treats the gases by condensing hydrocarbon vapors. Tray 120 collects the condensate. Condensed hydrocarbon is collected by tray 120 and routed back into the tank by collecting duct 160. Remaining gas is release into the atmosphere via vent 190.

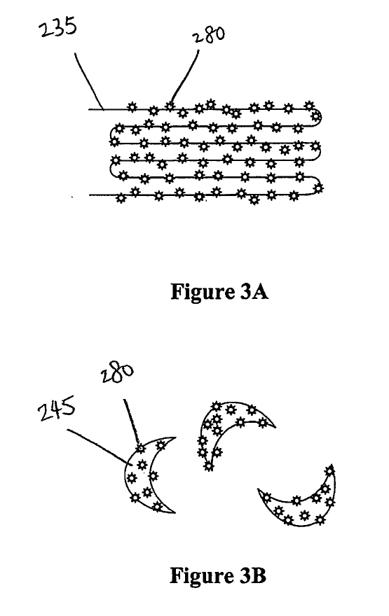

Condensation enhancer 140 generally has a carrier coupled to a carbonaceous nanostructured material. FIGS. 3A and 3B illustrates two embodiments of the carrier and will be discussed in more details below. It is contemplated that condensation enhancer 140 can have either embodiments.

FIG. 2 generally depicts a distillation column. A distillation column is generally used for separating a mixture of substances with narrow differences in boiling points. A distillation column is commonly used in chemical refineries. While FIG. 2 illustrates a distillation column with two cooling compartments 205A and 205B, contemplated distillation columns can have just one cooling compartment, or alternatively more than one cooling compartment.

A distillation column 200 typically includes a column 210 with various trays 220A, 220B disposed within the column at different heights. The trays have many openings allowing the vapor to pass through, and effectively increase the contact time between the vapor and the column. A temperature difference is created across the column, and the trays 220A, 220B help to collect condensates at various heights in different compartments 205A, 205B.

A vapor of a mixture of substances is introduced from an inlet 230 at the bottom of the column. As the vapor rises through the trays in the column, it cools. In addition, within the compartments 205A, 205B are disposed condensation enhancers 240A, 240B helping to lower the compartments to a desired temperature. Condensation enhancers 240A, 240B are coupled to refrigerators 250A, 250B. When a substance in the vapor reaches a height where the temperature of the column is equal to that substance's boiling point, it condenses to form a liquid. Thus, the substance with the lowest boiling point will condense at the highest point in the column; substances with higher boiling points will condense lower in the column. Condensates are then retrieved through collecting ducts 260A, 260B. Remaining gas exits from vent 290.

Condensation enhancer 240A, as shown in FIG. 2, is preferably comprised of a carrier connected to a refrigerator 250A. In less preferred embodiments a refrigerator is not provided. FIG. 3A shows carrier 235 preferably coated with carbonaceous nanostructured materials 280. It should be noted that the configuration of carrier shown in FIG. 3A is only an exemplary illustration. Various other possible configurations are contemplated, including coil, matrix, and radiating plates; the most preferred configuration being one that provides optimal surface-to-air area. Also, the carrier can be sized to fit different types and shapes of distillation column. The configuration and size of the carrier is really a design parameter, and all configuration and sizes are viable, including very small, miniscule, carriers.

It is generally contemplated that carrier 235 can be made of suitable materials to withstand temperature extreme and the chemical environment in the distillation column, such materials include natural and synthetic polymers, various metals and metal alloys, naturally occurring materials, textile fibers, glass and ceramic materials, sol-gel materials, and all reasonable combinations thereof. Flowing within the hollow carrier is preferably cooling refrigerant provided by the refrigerator, for cooling to a desired temperature.

In compartment 205B, it is contemplated that condensation enhancer 240B is comprised of a plurality of carriers 245 coated with carbonaceous nanostructured material 280. FIG. 3B is an exemplary illustration of such carriers. It is contemplated that condensation enhancer can or cannot be coupled to refrigerator 250B. The carriers 245 make contact with the vapor and allows condensation of target compound in the vapor to take place at a relatively lower temperature due to the carbonaceous nanomaterial coating on the carriers.

In other contemplated embodiments, refrigerators 250A, 250B can be controlled by controllers to provide a desired temperature at the condensation enhancers to condense a compound in a gas phase. Due to the carbonaceous nanostructured material in the condensation enhancers, the controller can set the temperature higher than normally required to condense hydrocarbon vapor.

It should be noted that cooling can be done by known methods of cooling, for example, electric, with liquid gases, by expansion (JT-cooling), or with regular refrigerant.

Carrier 245 in FIG. 3A is depicted as having a half-moon shape. However, other alternatives are contemplated. For example, carrier can be any other shapes and dimensions, including spherical, cylindrical, cubical., in form of a fabric, filter, and porous cover. A preferred carrier is spherical with a diameter of one inch. Alternatively the size may vary from very small (for example, small spheres with diameter of less than 5 mm), to very large (for example, cylinders more than 2 meters long). Similar to the carrier, the configuration and size of the carrier is really a design parameter, and all configuration and sizes are viable, including very small to very large.

It is generally contemplated that carrier is made of suitable material to withstand the environment in the distillation column. Such materials include natural and synthetic polymers, various metals and metal alloys, naturally occurring materials, textile fibers, glass and ceramic materials, sol-gel materials, and all reasonable combinations thereof. However, it is generally preferred that the material is at least in part permeable to a liquid and/or a gas, or shaped into a form that is permeable to a liquid and/or a gas (e.g., in form of a fabric, filter, porous cover, etc.).

In yet further embodiments, the target compound for condensation is at least partially substituted and at least partially unsaturated hydrocarbon having a boiling point of less than 100° C.

It is also contemplated that the temperature at the surface area effective to condense the compound in the gas phase is between 15° C. and −45° C.

It should be noted that the reverse is also true: contemplated configurations and methods may also be employed to increase the temperature at which a compound is released from the bound/liquid phase into the gas phase optional water removal due to frosting.

Thus, specific embodiments and applications of configurations and methods for assisted condensation have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Furthermore, where a definition or use of a term in a reference, which is incorporated by reference herein is inconsistent or contrary to the definition of that term provided herein, the definition of that term provided herein applies and the definition of that term in the reference does not apply.

What is claimed is:

1. An apparatus comprising:
a condensation enhancer comprising a carrier coupled to a carbonaceous nanostructured material;
wherein the nanostructured material is coupled to the carrier such that a compound in gas phase contacting the enhancer condenses at a temperature that is higher than a condensation temperature of the compound on the condensation enhancer without the nanostructured material.

2. The apparatus of claim 1 wherein the nanostructured material has a smallest dimension of less than 100 nm.

3. The apparatus of claim 1 wherein the nanostructured material has a smallest dimension of less than 50 nm.

4. The apparatus of claim 1 wherein the nanostructured material has a smallest dimension of less than 10 nm.

5. The apparatus of claim 1 wherein the carbonaceous nanostructured material is non-porous, and wherein the compound is at least partially substituted and at least partially unsaturated hydrocarbon having a boiling point of less than 100° C.

6. The apparatus of claim 1 wherein the carbonaceous nanostructured material includes a structure selected from the group consisting of a graphene, a carbon nanotube, and a fullerene.

7. The apparatus of claim 1 further comprising a thermal unit that is coupled to the enhancer and controlled by a controller to provide a temperature at the enhancer effective to condense a compound in a gas phase when the compound contacts the enhancer; and wherein the controller is configured to set the temperature to a temperature that is higher than a temperature that is required to condense the compound on the condensation enhancer without the nanostructured material.

8. The apparatus of claim 1 further comprising a distillation column coupled to the condensation enhancer.

9. The apparatus of claim 1 further comprising a storage tank coupled to the condensation enhancer and wherein the compound is gasoline vapors.

10. A surface area with nanostructured material comprising:
a nanostructured material having a smallest dimension of less than 100 nm;
wherein the nanostructured material is coupled to a surface area such that a compound in gas phase contacting the surface area condenses at a temperature that is higher than a condensation temperature of the compound on the surface area without the nanostructured material.

11. The apparatus of claim 10 wherein the nanostructured material is non-porous and carbon-linked.

12. The apparatus of claim 10 wherein the nanostructured material is carbonaceous and includes a structure selected from the group consisting of a graphene, a carbon nanotube, and a fullerene.

13. The apparatus of claim 10 wherein the nanostructured material has a smallest dimension of less than 50 nm.

14. The apparatus of claim 10 wherein the nanostructured material has a smallest dimension of less than 10 nm.

15. The apparatus of claim 10 wherein the temperature at the surface area effective to condense the compound in the gas phase is between 15° C. and −45° C.

16. A method of removing a compound in gas phase from a medium, comprising the steps of:
recognizing a compound that condenses at a first lower temperature under a condition;
recognizing a second temperature wherein the compound is sorbed unto a nanostructured material;
providing a condensation enhancer comprising a carrier coupled to the nanostructured material;
contacting the enhancer with the medium at the second temperature at which the compound condenses.

17. The method of claim 16 wherein the compound is at least partially substituted hydrocarbon and wherein the medium is air.

18. The method of claim 16 wherein the step of contacting includes coupling the enhancer to a conduit through which the medium is passed, and wherein the enhancer is refrigerated to the temperature.

19. The method of claim 18 wherein the enhancer is configured as a cold exchanger, and wherein the enhancer is coated with the carbonaceous nanostructured material.

20. The method of claim 16 wherein the carbonaceous nanostructured material comprises a material selected from the group consisting of a graphene, a carbon nanotube, and a fullerene.
